(19) United States
(12) Patent Application Publication
(10) Pub. No.: US 2009/0226801 A1
(43) Pub. Date: Sep. 10, 2009

(54) Leakproof electrode assembly

(75) Inventor: Shen-Fu Wu, Fongshan City (TW)

Correspondence Address: BACON & THOMAS, PLLC, 625 SLATERS LANE, FOURTH FLOOR, ALEXANDRIA, VA, 22314-1176, US

(73) Assignee: Kuang-Yu CHEN, Kaohsiung Hsien (TW)

(21) Appl. No.: 12/073,595

(22) Filed: Mar. 7, 2008

(51) Int. Cl. H01M 2/00

(52) U.S. Cl. 429/122

(57) ABSTRACT

A leakproof electrode assembly is mounted in a plastic cover of a storage battery and has a body, a main flange and at least one enhanced flange. The main flange is formed around the body. The at least one enhanced flange is formed around the body and has a top surface, a bottom surface, an outer edge, an upper rib, a lower rib and a groove. The upper and lower ribs are respectively formed on and protrude from the top and bottom surface of the enhanced flange near the outer edge. The groove is formed around the outer edge of the enhanced flange. During combining the plastic cover with the electrode assembly, the upper and lower ribs and the groove provide more contacting surfaces to keep the plastic cover from fully departing from the enhanced flange and to keep liquid inside the battery from leaking out.

### BACKGROUND OF THE INVENTION

1. Field of the Invention

The present invention relates to a leakproof electrode assembly, and more particularly to an electrode assembly mounted on a storage battery prevents leaking of the liquid inside the storage battery.

2. Description of Related Art

With reference to FIG. 7, a conventional electrode assembly (40) is applied on a storage battery to form a pole of the storage battery for an electric wire to connect on, is tubular and has an annular sidewall, a mounting end, a main flange (42) and multiple enhanced flanges (43).

The main flange (42) is formed around the annular sidewall of the electronic assembly (40).

The enhanced flanges (43) are separately formed around and protrudes from the annular sidewall of the electronic assembly (40) between the main flange (42) and the mounting end and each enhanced flange (43) has two flat sides and a flat outer edge.

With further reference to FIGS. 8 and 9, during manufacturing storage batteries, a mold for forming a plastic cover (60) is used to load the electrode assembly (40) then fills with melted plastic around the main flange (42) and the enhanced flanges (43) of the electrode assembly (40) such that connect the plastic cover (60) with the main flange (42) and the enhanced flanges (43) of the electrode assembly (40). However, the plastic may shrink when turning cold and then departs from combination with the sides and outer edge of the enhanced flange (43) because the flat surfaces provide little friction to hold the plastic. Therefore, seams (61) may be formed between the plastic cover (60) and the electrode assembly (40) and may lead to leaking of the liquid inside the storage battery.

To overcome the shortcomings, the present invention provides a leakproof electrode assembly to mitigate or obviate the aforementioned problems.

### SUMMARY OF THE INVENTION

The main objective of the invention is to provide a leakproof electrode assembly mounted on a storage battery such that prevents leaking of the liquid inside the storage battery.

The leakproof electrode assembly is mounted in a plastic cover of the storage battery and has a body, a main flange and at least one enhanced flange. The main flange is formed around the body. The at least one enhanced flange is formed around the body and has a top surface, a bottom surface, an outer edge, an upper rib, a lower rib and a groove. The upper and lower ribs are respectively formed on and protrudes from the top and bottom surface of the enhanced flange near the outer edge. The groove is formed around the outer edge of the enhanced flange. Consequently, during combining the plastic cover with the electrode assembly, the upper and lower ribs and the groove provide more contacting surfaces such that keeps the plastic cover from fully departing from the enhanced flange and keeps the liquid inside the battery from leaking out when the plastic cover shrinks.

Other objectives, advantages and novel features of the invention will become more apparent from the following detailed description when taken in conjunction with the accompanying drawings.

### BRIEF DESCRIPTION OF THE DRAWINGS

FIG. 1 is a cross-sectional perspective view of a leakproof electrode assembly in accordance with the present invention;

FIG. 2 is another cross-sectional perspective view of the leakproof electrode assembly in FIG. 1;

FIG. 3 is a cross-sectional side view of the leakproof electrode assembly in FIG. 1;

FIG. 4 is an operational side view of the leakproof electrode assembly in FIG. 1 applied in a storage battery;

FIG. 5 is an operational cross-sectional side view of the leakproof electrode assembly in FIG. 4, shown combined with a plastic cover of a storage battery;

FIG. 6 is an enlarged operational cross-sectional side view of the leakproof electrode assembly in FIG. 4, shown contacting portion of at least one enhanced flange of the electrode assembly;

FIG. 7 is a cross-sectional side view of a conventional electrode assembly in accordance with the prior art;

FIG. 8 is an operational side view of the conventional electrode assembly in FIG. 7 applied in a storage battery; and

FIG. 9 is an enlarged operational cross-sectional side view of the conventional electrode assembly in FIG. 8, shown contacting portion of multiple enhanced flanges of the electrode assembly.

### DETAILED DESCRIPTION OF PREFERRED EMBODIMENT

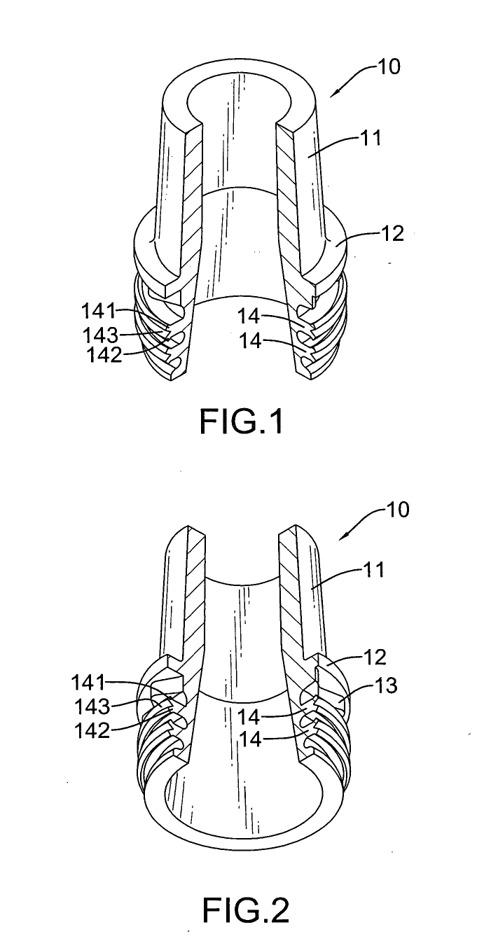

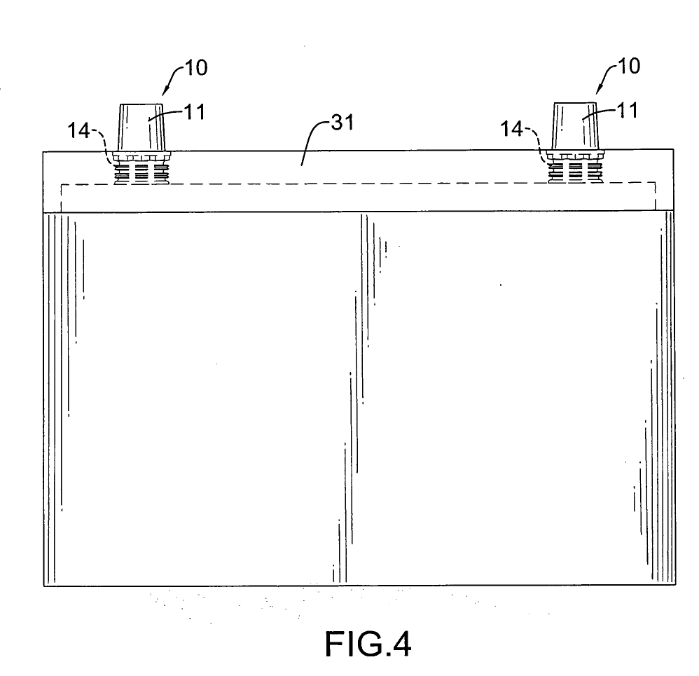

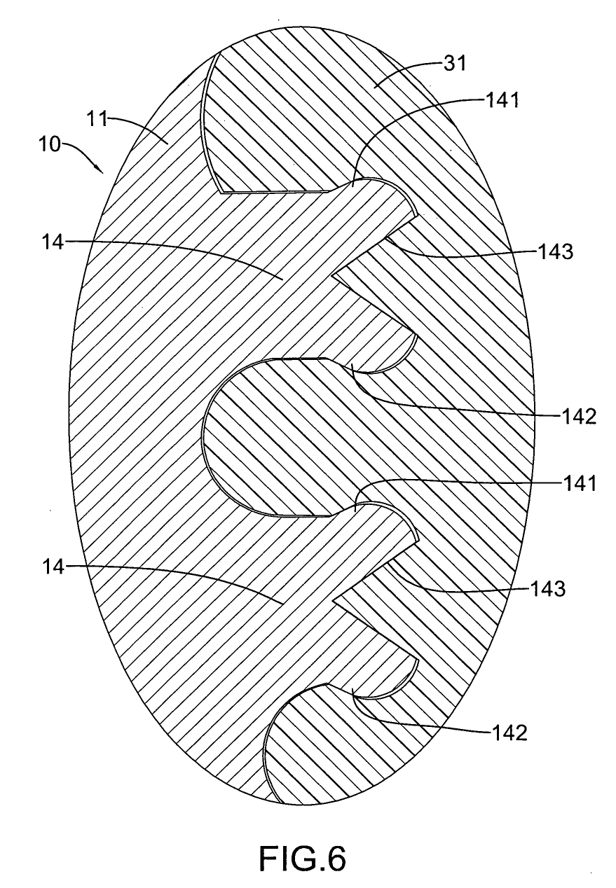

With reference to FIGS. 1, 2 and 4, a leakproof electrode assembly (10) in accordance with the present invention is mounted in a plastic cover (31) of a storage battery (30) and comprises a body (11), a main flange (12), multiple optional enhanced protrusions (13) and at least one enhanced flange (14).

The body (11) is tubular and has an annular sidewall and a lower end.

The main flange (12) is formed around the sidewall of the body (11).

The enhanced protrusions (13) are adjacent to each other, protrude from and are formed around the sidewall of the body (11) adjacent to the main flange (12) to provide more contacting surface.

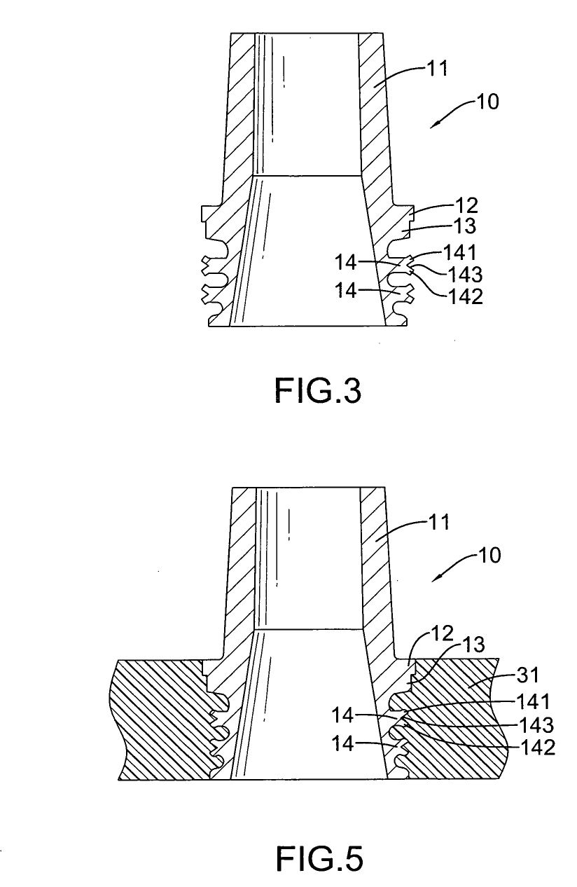

With further reference to FIG. 3, the at least one enhanced flange (14) is formed around and protrudes from the sidewall of the body (11) between the main flange (12) and the lower end. Each enhanced flange (14) has a top surface, a bottom surface, an outer edge, an upper rib (141), a lower rib (142) and a groove (143).

The upper rib (141) is formed on and protrudes upwards from the top surface of the enhanced flange (14) at the outer edge.

The lower rib (142) is formed on and protrudes downwards from the bottom surface of the enhanced flange (14) at the outer edge.

The groove (143) is formed annularly in the outer edge of the enhanced flange (14) between the upper and lower ribs (141, 142) and may be V-shaped in cross section.

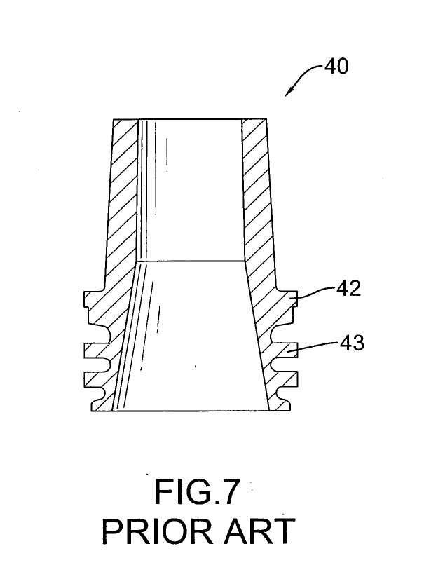

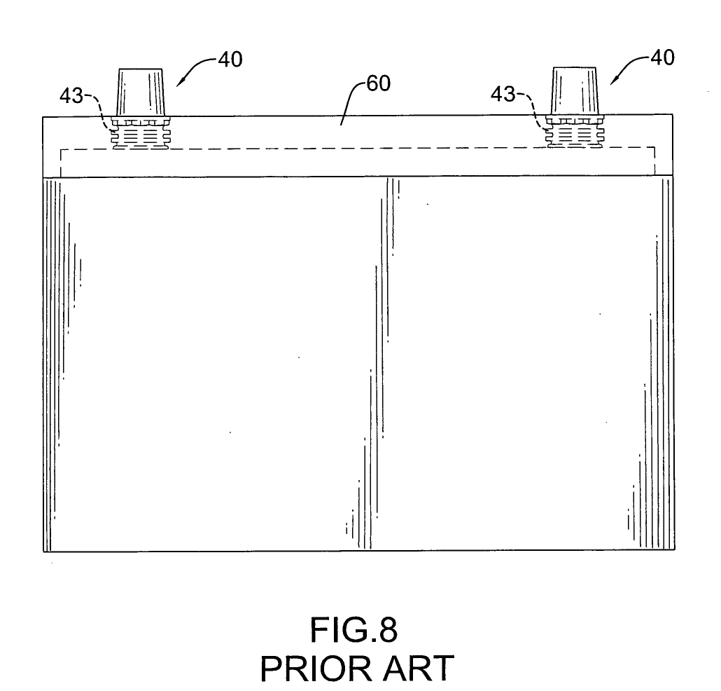

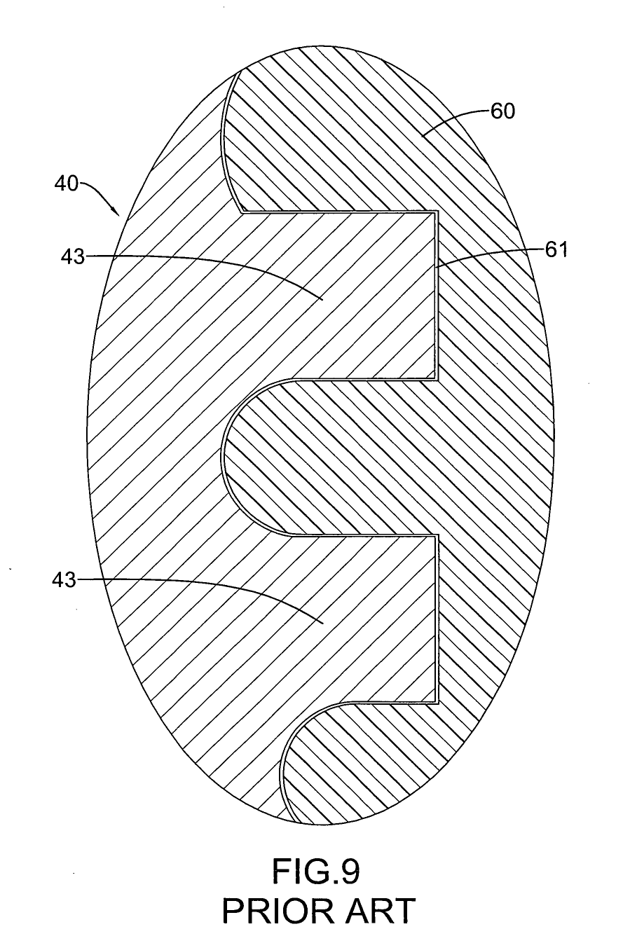

With further reference to FIGS. 5 and 6, during combining the plastic-cover (31) with the electrode assembly (10), the upper and lower ribs (141, 142) and the groove (143) provide more contacting surfaces with the plastic cover (30). When the plastic cover (30) is cooled down and shrinks, the added contacting surfaces keep the plastic cover (30) from fully departing from the enhanced flange (14). Therefore, even when the plastic cover (30) shrinks, the plastic cover (30) still partially contacts with the enhanced flange (14) to keeps the seams between the plastic cover (30) and the enhanced flange from communicating. Thus, the electrode assembly (10) as described effectively keeps the liquid inside the storage battery from leaking out.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A leakproof electrode assembly comprising:
a body being tubular and having
an annular sidewall; and
a lower end;
a main flange being formed around the sidewall of the body of the electrode assembly; and
at least one enhanced flange being formed around and protrudes from the sidewall of the body between the main flange and the lower end, and each one of the at least one enhanced flange having
a top surface;
a bottom surface;
an outer edge;
an upper rib being formed on and protruding upwards from the top surface of the enhanced flange near the outer edge;
a lower rib being formed on and protruding downwards from the bottom surface of the enhanced flange near the outer edge; and
a groove being formed in and around the outer edge of the enhanced flange between the upper and lower ribs.

2. The leakproof electrode assembly as claimed in claim 1, wherein the groove of each one of the at least one enhanced flange is V-shaped in cross section.

3. The leakproof electrode assembly as claimed in claim 2 further comprising multiple enhanced protrusions being adjacent to each other, protruding from and being formed around the sidewall of the body and being adjacent to the main flange.
